(19) United States
(12) Patent Application Publication
(10) Pub. No.: US 2025/0092195 A1
(43) Pub. Date: Mar. 20, 2025

(54) FLUOROPOLYETHER GROUP-CONTAINING COMPOUND

(71) Applicant: DAIKIN INDUSTRIES, LTD., Osaka (JP)

(72) Inventors: Hideyuki IKEUCHI, Osaka (JP); Masato Naitou, Osaka (JP); Motoshi Matsui, Osaka (JP); Takashi Nomura, Osaka (JP)

(73) Assignee: DAIKIN INDUSTRIES, LTD., Osaka (JP)

(21) Appl. No.: 18/963,460

(22) Filed: Nov. 27, 2024

Related U.S. Application Data
(63) Continuation of application No. 17/679,282, filed on Feb. 24, 2022.
Application No. 17/679,282 is a continuation of application No. PCT/JP2020/034137, filed on Sep. 9, 2020.

(30) Foreign Application Priority Data
Sep. 26, 2019 (JP) 2019-176063

(51) Int. Cl. C08G 65/333; C08G 65/329; C08G 65/331; C08G 65/336

(52) U.S. Cl. CPC C08G 65/33396; C08G 65/329; C08G 65/331; C08G 65/33317; C08G 65/336

(57) ABSTRACT

A fluoropolyether group-containing compound of formula (1a) or formula (1b):

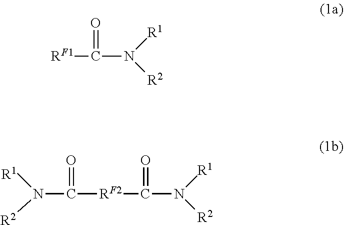

wherein R^{F1}, R^{F2}, R¹ and R² are as defined herein.

### CROSS REFERENCE TO RELATED APPLICATIONS

This application is a Rule 53(b) Continuation of U.S. application Ser. No. 17/679,282 filed Feb. 24, 2022, which is a Rule 53(b) Continuation of International Application No. PCT/JP2020/034137 filed Sep. 9, 2020, claiming priority based on Japanese Patent Application No. 2019-176063 filed Sep. 26, 2019, the disclosures of which are incorporated herein by reference in their entireties.

### TECHNICAL FIELD

The present disclosure relates to a fluoropolyether group-containing compound.

### BACKGROUND ART

Compounds having a fluoropolyether group are used in various applications. For example, a compound having a fluoropolyether group in the molecular backbone and a hydrolyzable group bonded to a Si atom is used as a compound used for surface treatment of a base material (for example, Patent Document 1 and the like).

The compound described in Patent Document 1 is usually formed by introducing a functional group (in Patent Document 1, a hydrolyzable group bonding to a Si atom) into an intermediate having a fluoropolyether group. That is, it is necessary for the intermediate as described above to have a site into which another functional group can be introduced.

For example, Patent Document 2 describes fluoropolyether group-containing compounds. The compounds described in Patent Document 2 have —CH₂OH, —CH₂NH₂, or —CHO present at the ends. Specifically, in Example 1 of Patent Document 2, a compound having a —CH₂NH₂ group at the end is formed, and in Example 9, a compound having a —CHO group at the end is formed. Other functional group can be introduced into the site which comprises the aldehyde group or the like present at the end of the compound in Patent Document 2.

### CITATION LIST

### Patent Document

Patent Document 1: JP 2014-218639 A
Patent Document 2: JP 2004-68007 A

### SUMMARY OF THE INVENTION

The present disclosure provides [1] below. [1]A fluoropolyether group-containing compound of formula (1a) or formula (1b):

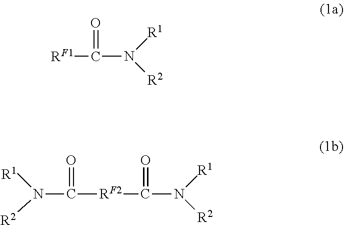

wherein
   R^{F1} is each independently at each occurrence Rf¹—R^{F}—O_{q}—;
   R^{F2} is —Rf²ₚ—R^{F}—O_{q}—;
   Rf¹ is each independently at each occurrence a C₁₋₁₆ alkyl group optionally substituted with one or more fluorine atoms;
   Rf² is a C₁₋₆ alkylene group optionally substituted with one or more fluorine atoms;
   R^{F} is each independently at each occurrence a divalent fluoropolyether group;
   p is 0 or 1;
   q is each independently at each occurrence 0 or 1; and
   R¹ and R², each independently at each occurrence, are an alkyl group or an alkoxy group having 1 to 10 carbon atoms, or together form a group having a ring structure which is a 5 to 10-membered heterocyclic ring, or together form a group having a ring structure which is a condensed ring containing a 5 to 10-membered heterocyclic ring, wherein the alkyl group, the alkoxy group and the group having the ring structure may be substituted.

### Advantageous Effect

According to the present disclosure, it is possible to provide a novel fluoropolyether group-containing compound. By using the compound of the present disclosure as a reaction raw material, it is possible to provide a compound having an aldehyde group at an end, wherein the aldehyde group is a site where other functional group can be easily introduced, under milder conditions, specifically, conditions that do not require heating and refluxing.

### DETAILED DESCRIPTION OF THE PREFERRED EMBODIMENTS

The “monovalent organic group”, as used herein, means a monovalent group containing a carbon. The monovalent organic group is not limited, and may be a hydrocarbon group or a derivative thereof. A derivative of a hydrocarbon group means a group having one or more of N, O, S, Si, amide, sulfonyl, siloxane, carbonyl, carbonyloxy, and the like at the terminal or in the molecular chain thereof. When “organic group” is used, it means a monovalent organic group.

The “divalent organic group” means a divalent group containing carbon. The divalent organic group is not limited, and examples include a divalent group obtained by further removing one hydrogen atom from an organic group.

The “hydrocarbon group”, as used herein, means a group that contains carbon and hydrogen and that is obtained by removing one hydrogen atom from a hydrocarbon. The hydrocarbon group is not limited, and examples include a C₁₋₂₀ hydrocarbon group that is optionally substituted with one or more substituents, such as an aliphatic hydrocarbon group and an aromatic hydrocarbon group. The “aliphatic hydrocarbon group” may be either linear, branched, or cyclic, and may be either saturated or unsaturated. The hydrocarbon group may contain one or more ring structures.

The substituent of the “hydrocarbon group”, as used herein, is not limited, and examples include one or more groups selected from a halogen atom, and a C₁₋₆ alkyl group, a C₂₋₆ alkenyl group, a C₂₋₆ alkynyl group, a C₃₋₁₀ cycloalkyl group, a C₃₋₁₀ unsaturated cycloalkyl group, a 5 to 10-membered heterocyclyl group, a 5 to 10-membered unsaturated heterocyclyl group, a C₆₋₁₀ aryl group, and a 5 to 10-membered heteroaryl group each optionally substituted with one or more halogen atoms.

The “hydrolyzable group”, as used herein, means a group capable of undergoing a hydrolysis reaction, i.e., means a group that can be removed from the main backbone of a compound by a hydrolysis reaction. Examples of the hydrolyzable group include —OR^{h}, —OCOR^{h}, —O—N═CR^{h}₂, —NR^{h}₂, —NHR^{h}, and halogen (in these formulae, R^{h} represents a substituted or unsubstituted C₁₋₄ alkyl group).

### First Embodiment

The present embodiment relates to a fluoropolyether group-containing compound represented by the following formula (1a) or formula (1b).

By using the compound of the present embodiment as a reaction raw material, it is possible to provide a compound having an aldehyde group under milder conditions, specifically, conditions that do not require heating and refluxing. By reacting a compound having an aldehyde group with another compound, it is possible to introduce substituents.

Formula (1a) or formula (1b):

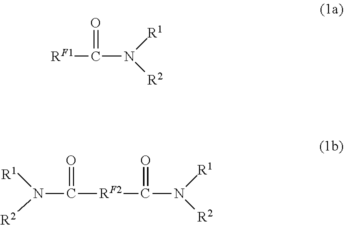

In formula (1a), R^{F1} is each independently at each occurrence Rf¹—R^{F}—O_{q}—.

In formula (1b), R^{F2} is —Rf²ₚ—R^{F}—O_{q}—.

In the formula, Rf¹ is each independently at each occurrence a C₁₋₁₆ alkyl group optionally substituted with one or more fluorine atoms.

The “C₁₋₁₆ alkyl group” in the C₁₋₁₆ alkyl group optionally substituted with one or more fluorine atoms may be linear or branched, and is preferably a linear or branched C₁₋₆ alkyl group, particularly C₁₋₃ alkyl group, more preferably a linear C₁₋₆ alkyl group, particularly C₁₋₃ alkyl group.

Rf¹ is preferably a C₁₋₁₆ alkyl group substituted with one or more fluorine atoms, more preferably a CF₂H—C₁₋₁₅ perfluoroalkylene group, and even more preferably a C₁₋₁₆ perfluoroalkyl group.

The C₁₋₁₆ perfluoroalkyl group may be linear or branched, and is preferably a linear or branched C₁₋₆ perfluoroalkyl group, particularly C₁₋₃ perfluoroalkyl group, more preferably a linear C₁₋₆ perfluoroalkyl group, particularly C₁₋₃ perfluoroalkyl group; specifically, —CF₃, —CF₂CF₃, or —CF₂CF₂CF₃.

In the formula, Rf² is a C₁₋₆ alkylene group optionally substituted with one or more fluorine atoms.

The “C₁₋₆ alkylene group” in the C₁₋₆ alkylene group optionally substituted with one or more fluorine atoms may be linear or branched, and is preferably a linear or branched C₁₋₃ alkylene group, and more preferably a linear C₁₋₃ alkylene group.

Rf² is preferably a C₁₋₆ alkylene group substituted with one or more fluorine atoms, more preferably a C₁₋₆ perfluoroalkylene group, and even more preferably a C₁₋₃ perfluoroalkylene group.

The C₁₋₆ perfluoroalkylene group may be linear or branched, and is preferably a linear or branched C₁₋₃ perfluoroalkylene group, and more preferably a linear C₁₋₃ perfluoroalkylene group; specifically, —CF₂—, —CF₂CF₂—, or —CF₂CF₂CF₂—.

In the formula, p is 0 or 1. In one embodiment, p is 0. In another embodiment, p is 1.

In the formula, q is each independently at each occurrence 0 or 1. In one embodiment, q is 0. In another embodiment, q is 1.

In the formulas (1a) and (1b), R^{F} is each independently at each occurrence a divalent fluoropolyether group.

R^{F} is preferably a fluoropolyether group represented by formula:

(OC₆F₁₂)ₐ—(OC₅F₁₀)_{b}—(OC₄F₈)_{c}—(OC₃F₆)_{d}—(OC₂F₄)ₑ—(OCF₂)_{f}—

In the formula,
a, b, c, d, e and f are each independently an integer of 0 to 200, the sum of a, b, c, d, e and f is 1 or more, and the occurrence order of the respective repeating units enclosed in parentheses provided with a, b, c, d, e or f is not limited in the formula.
a, b, c, d, e and f may preferably each independently be an integer of 0 to 100.

The sum of a, b, c, d, e and f is preferably 5 or more, more preferably 10 or more, and may be, for example, 15 or more and 20 or more. The sum of a, b, c, d, e, and f is preferably 200 or less, more preferably 100 or less, even more preferably 60 or less, and may be, for example, 50 or less or 30 or less.

These repeating units may be linear or branched, and are preferably linear. For example, —(OC₆F₁₂)— may be —(OCF₂CF₂CF₂CF₂CF₂CF₂)—, —(OCF(CF₃)CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, —(OCF₂CF₂CF₂CF₂CF(CF₃))—, or the like, and is preferably —(OCF₂CF₂CF₂CF₂CF₂CF₂)—. —(OC₅F₁₀)— may be —(OCF₂CF₂CF₂CF₂CF₂)—, —(OCF(CF₃)CF₂CF₂CF₂)—, —(OCF₂CF(CF₃)CF₂CF₂)—, (OCF₂CF₂CF(CF₃)CF₂)—, —(OCF₂CF₂CF₂CF(CF₃))—, or the like, and is preferably —(OCF₂CF₂CF₂CF₂CF₂)—. —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)— and —(OCF₂CF(C₂F₅))—, and is preferably —(OCF₂CF₂CF₂CF₂)—. —(OC₃F₆)— may be any of —(OCF₂CF₂CF₂)—, —(OCF(CF₃)CF₂)— and —(OCF₂CF(CF₃))—, and is preferably —(OCF₂CF₂CF₂)—. Also, —(OC₂F₄)— may be any of —(OCF₂CF₂)— and —(OCF(CF₃))—, and is preferably —(OCF₂CF₂)—.

In one embodiment, R^{F} is each independently at each occurrence represented by the following formula (f1), (f2), (f3), (f4), or (f5):

(OC₃F₆)_{d}—(OC₂F₄)ₑ— (f1)

wherein d is an integer of 1 to 200, and e is 1,

—(OC₄F₈)_{c}—(OC₃F₆)_{d}—(OC₂F₄)ₑ—(OCF₂)_{f}— (f2)

wherein c and d are each independently an integer of 0 or more and 30 or less, and e and f are each independently an integer of 1 or more and 200 or less;
the sum of c, d, e, and f is 2 or more; and
the occurrence order of the respective repeating units enclosed in parentheses provided with the subscription c, d, e or f is not limited in the formula,

—(R⁶—R⁷)_{g}— (f3)

wherein R⁶ is OCF₂ or OC₂F₄;
R⁷ is a group selected from OC₂F₄, OC₃F₆, OC₄F₈, OC₅F₁₀, and OC₆F₁₂, or a combination of two or three groups independently selected from these groups; and
g is an integer of 2 to 100,

(OC₆F₁₂)ₐ—(OC₅F₁₀)_{b}—(OC₄F₈)_{c}—(OC₃F₆)_{d}—(OC₂F₄)ₑ—(OCF₂)_{f}— (f4)

wherein e is an integer of 1 or more and 200 or less, a, b, c, d, and f are each independently an integer of 0 or more and 200 or less, the sum of a, b, c, d, e and f is at least 1, and the occurrence order of the respective repeating units enclosed in parentheses provided with a, b, c, d, e or f is not limited in the formula,

(OC₆F₁₂)ₐ—(OC₅F₁₀)_{b}—(OC₄F₈)_{c}—(OC₃F₆)_{d}—(OC₂F₄)ₑ—(OCF₂)_{f}— (f5)

wherein f is an integer of 1 or more and 200 or less, a, b, c, d, and e are each independently an integer of 0 or more and 200 or less, the sum of a, b, c, d, e and f is at least 1, and the occurrence order of the respective repeating units enclosed in parentheses provided with a, b, c, d, e or f is not limited in the formula.

In the formula (f1), d is preferably an integer of 5 to 200, more preferably 10 to 100, and even more preferably 15 to 50, for example, 25 to 35. The formula (f1) is preferably a group represented by —(OCF₂CF₂CF₂)_{d}—(OC₂F₄)ₑ— or —(OCF(CF₃)CF₂)_{d}—(OC₂F₄)ₑ—, and more preferably a group represented by —(OCF₂CF₂CF₂)_{d}—(OC₂F₄)ₑ—.

In the formula (f2), e and f are each independently an integer of preferably 5 or more and 200 or less, and more preferably 10 to 200. Further, the sum of c, d, e, and f is preferably 5 or more, more preferably 10 or more, for example, 15 or more and 20 or less. In one embodiment, the formula (f2) is preferably a group represented by —(OCF₂CF₂CF₂CF₂)_{c}—(OCF₂CF₂CF₂)_{d}—(OCF₂CF₂)ₑ—(OCF₂)_{f}—. In another embodiment, formula (f2) may be a group represented by —(OC₂F₄)ₑ—(OCF₂)_{f}—.

In the formula (f3), R⁶ is preferably OC₂F₄. In the formula (f3), R⁷ is preferably a group selected from OC₂F₄, OC₃F₆ and OC₄F₈, or a combination of two or three groups independently selected from these groups, and more preferably a group selected from OC₃F₆ and OC₄F₈. Examples of the combination of two or three groups independently selected from OC₂F₄, OC₃F₆ and OC₄F₈ include, but are not limited to —OC₂F₄OC₃F₆—, —OC₂F₄OC₄F₈—, —OC₃F₆OC₂F₄—, —OC₃F₆OC₃F₆—, —OC₃F₆OC₄F₆—, —OC₄F₈OC₄F₈—, —OC₄F₆OC₃F₆—, —OC₄F₆OC₂F₄—, —OC₂F₄OC₂F₄OC₃F₆—, —OC₂F₄OC₂F₄OC₄F₈—, —OC₂F₄OC₃F₆OC₂F₄—, —OC₂F₄OC₃F₆OC₃F₆—, —OC₂F₄OC₄F₈OC₂F₄—, —OC₃F₆OC₂F₄OC₂F₄—, —OC₃F₆OC₂F₄OC₃F₆—, —OC₃F₆OC₃F₆OC₂F₄—, and —OC₄F₆OC₂F₄OC₂F₄—. In the formula (f3), g is preferably an integer of 3 or more, and more preferably 5 or more. g is preferably an integer of 50 or less. In the formula (f3), OC₂F₄, OC₃F₆, OC₄F₈, OC₅F₁₀, and OC₆F₁₂ may be either linear or branched, and are preferably linear. In this embodiment, the formula (f3) is preferably —(OC₂F₄—OC₃F₆)_{g}— or —(OC₂F₄—OC₄F)_{g}—.

In the formula (f4), e is preferably an integer of 1 or more and 100 or less, and more preferably 5 or more and 100 or less. The sum of a, b, c, d, e and f is preferably 5 or more, and more preferably 10 or more, for example, 10 or more and 100 or less.

In the formula (f5), f is preferably an integer of 1 or more and 100 or less, and more preferably 5 or more and 100 or less. The sum of a, b, c, d, e and f is preferably 5 or more, and more preferably 10 or more, for example, 10 or more and 100 or less.

In one embodiment, R^{F} is a group represented by the formula (f1).

In one embodiment, R^{F} is a group represented by the formula (f2).

In one embodiment, R^{F} is a group represented by the formula (f3).

In one embodiment, R^{F} is a group represented by the formula (f4).

In one embodiment, R^{F} is a group represented by the formula (f5).

The ratio of e to f in R^{F} (hereinafter referred to as an “e/f ratio”) is 0.1 to 10, preferably 0.2 to 5, more preferably 0.2 to 2, and even more preferably 0.2 to 1.5. In the present embodiment, f is an integer of 1 or more.

For example, when a hydrolyzable group bonded to a Si atom is introduced into the end of the fluoropolyether group-containing compound of the present embodiment to form a final product, the final product can be used as a surface-treating agent for a base material. With the e/f ratio within the above range, the lubricity, friction durability, and chemical resistance (such as durability against (human) sweat) of a surface-treating layer obtained from the final product are further increased. The smaller the e/f ratio is, the higher the lubricity and the friction durability of the surface-treating layer are. On the other hand, with an e/f ratio of 0.1 or more, the stability of the final product can be further increased. The larger the e/f ratio is, the higher the stability of the final product is.

In one embodiment, the e/f ratio is preferably 0.2 to 0.9, more preferably 0.2 to 0.85, and even more preferably 0.2 to 0.8.

In one embodiment, from the viewpoint of heat resistance, the e/f ratio is preferably 0.4 or more, and more preferably 0.4 to 1.5.

In one embodiment, from the viewpoint of heat resistance, the e/f ratio may be, for example, 0.9 to 5.0, may be 0.9 to 2.0, or may be 0.9 to 1.5. The lower limit of the e/f ratio is preferably 1.0 or more, and may be, for example, 1.1 or more, or 1.3 or more.

The number average molecular weight of the R^{F1} and R^{F2} moiety is not limited, and is, for example, 500 to 30,000, preferably 1,500 to 30,000, and more preferably 2,000 to 10,000. Herein, the number average molecular weight of R^{F1} and R^{F2} are values measured by 1⁹F-NMR.

In another embodiment, the number average molecular weight of R^{F1} and R^{F2} moiety can be 500 to 30,000, preferably 1,000 to 20,000, more preferably 2,000 to 15,000, and even more preferably 2,000 to 10,000, for example, 3,000 to 8,000.

In the compound represented by formula (1a) or (1b) of the present embodiment, a group represented by —C(═O)N is directly bonded to R^{F1} or R^{F2}. By having such a structure, the reactivity of the compound of the present embodiment becomes favorable, and a compound having an aldehyde group can be provided under milder conditions by using the compound of the present embodiment as a reaction raw material. By having the above structure, when the compound of the present embodiment is used as a reaction raw material, the reaction can be easily controlled.

R¹ and R², each independently at each occurrence, are an optionally substituted monovalent organic group, or together form a group having an optionally substituted heterocyclic ring structure.

In one embodiment, R¹ and R² are each independently at each occurrence an optionally substituted monovalent organic group.

In one embodiment, R¹ and R² are together form a group having an optionally substituted heterocyclic ring structure.

In R¹ and R², the monovalent organic group is, for example, a monovalent group having 1 to 10 carbon atoms.

Examples of the monovalent organic group in R¹ and R² include an alkyl group, an alkoxy group, a benzotriazole group, a pyrrole group, a morpholino group, a benzyl group, a phenyl group, and a phenoxy groups, and these groups (specifically, hydrogen atom) may be substituted by a substituent. When R¹ and R² are monovalent organic groups, R¹ and R² are preferably unsubstituted monovalent organic groups.

When R¹ and R² are monovalent organic groups, R¹ and R² are each independently at each occurrence preferably an alkyl group or alkoxy group, more preferably a C₁₋₁₀ alkyl group (preferably a C₁₋₄ alkyl group such as a methyl group, an ethyl group, a propyl group, an isopropyl group), and a C₁₋₁₀ alkoxy group (preferably a C₁₋₄ alkoxy group such as a methoxy group, an ethoxy group, a propoxy group, an isopropoxy group), and even more preferably a methyl group and a methoxy group.

In one embodiment, when R¹ and R² are monovalent organic groups, one of R¹ and R² is an alkyl group and the other is an alkoxy group. Specifically, one of R¹ and R² is a C₁₋₁₀ alkyl group and the other is a C₁₋₁₀ alkoxy group, preferably one is a C₁₋₄ alkyl group (in particular a methyl group, an ethyl group, a propyl group, an isopropyl group) and the other is a C₁₋₄ alkoxy group (in particular a methoxy group, an ethoxy group, a propoxy group, an isopropoxy group), and more preferably one is a methyl group and the other is a methoxy group.

In the compounds of formulas (1a) and (1b) having the structure of the present embodiment, there are oxygen atoms of the amide group (i.e., the group represented by —C(═O)N) and oxygen atoms present in the vicinity of (for example, adjacent to) the nitrogen atom of the amide group. By having such a structure, control of the reaction using the compound of the present embodiment can be facilitated. It is considered that this is because the reactivity of the compound of the present embodiment can be improved by having such a structure.

In addition, it is considered that when the compound of the present embodiment is used as a reaction raw material and a metal catalyst, specifically, a Grignard reagent or an organolithium compound (for example, alkyllithium) is used together, a metal atom, for example, Mg or Li, and the two oxygen atoms of the compound are coordinated. As a result, control of the reaction can be further facilitated.

Further, the compound having the structure of the present embodiment is advantageous in terms of stability of the compound.

In other words, the heterocyclic ring structure is a ring structure wherein the ring structure is formed with the N atom to which R¹ and R² are bonded, R¹, and R². For example, when R¹ and R² together form the groups of the above-described heterocyclic ring structure, formulas (1a) and (1b) are represented as follows. In the following formulas, “W” is a heterocyclic ring structure which is formed with R¹ and R² together, and the heterocyclic ring structure (specifically, the hydrogen atom) may be substituted. The heterocyclic ring structure may have an unsaturated bond in the ring structure.

Examples of the unsaturated bond include a carbon-carbon unsaturated bond, a carbon-nitrogen unsaturated bond, and a nitrogen-nitrogen unsaturated bond.

Note that the following description is not intended to exclude the case where in formula (1b), in the two pairs of R¹ and R², one pair is a ring structure and the other is a monovalent organic group.

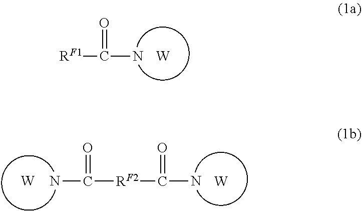

W may be a group containing 2 to 10 carbon atoms in the ring structure.

W may be a 5 to 10-membered heterocyclic ring or a condensed ring containing a heteroatom in the ring structure.

In the present embodiment, the heterocyclic ring of the 5 to 10-membered heterocyclic ring means to have a single ring. That is, the heterocyclic ring means that it does not have a condensed ring.

In one embodiment, W may be a group containing 1 to 4 heteroatoms in the ring structure. The 1 to 4 heteroatoms include a N atom directly bonded to a carbonyl group.

Preferably, W is a group having 2 to 10 carbon atoms in the ring structure, and the group has 1 to 4 heteroatoms in the ring structure.

Examples of the heteroatom include N atom, O atom, and S atom, preferably N atom and O atom.

In one embodiment, when W contains a heteroatom in addition to the N atom directly bonded to the carbonyl group, the heteroatom is an O atom or one or more N atoms.

In the examples of the condensed ring, R¹ and R² together form a group having a ring structure, and the ring structure includes a 5 to 10-membered heterocyclic ring as a condensed ring, preferably a 5 to 7-membered heterocyclic ring as a condensed ring. The heterocyclic structure may have an unsaturated bond in the ring structure.

The condensed ring may be formed by bonding two or more ring structures by sharing two or more atoms, and specifically, may be formed by bonding the 5 to 10-membered heterocyclic ring and a ring structure other than the heterocyclic ring by sharing two adjacent atoms. Examples of the ring structure other than the heterocyclic ring include a 5 to 10-membered ring structure, preferably a 5 to 7-membered ring structure, and more preferably a 5 or 6-membered ring structure, in particular a benzene ring, and a nitrogen-containing six membered ring, and preferably a benzene ring. Examples of the nitrogen-containing six membered ring include the following structures. In the following description, the atom denoted by “#” is an atom shared with a 5 to 10-membered heterocyclic ring.

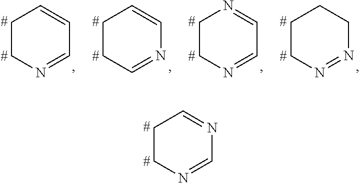

In one embodiment, when R¹ and R² together form a group having a ring structure, examples of the ring structure include a 5 to 10-membered heterocyclic ring (preferably a 5 to 7-membered heterocyclic ring) or a condensed ring containing a heteroatom in the ring structure. The condensed ring preferably contains a 5 to 10-membered heterocyclic ring (preferably a 5 to 7-membered heterocyclic ring), and more preferably has a ring structure in which the 5 to 10-membered heterocyclic ring is condensed with a benzene ring or a nitrogen-containing six membered ring. The heterocyclic structure may have an unsaturated bond in the ring structure.

Examples of the 5 to 10-membered heterocyclic ring include the following structures. In the following structures, “*” represents a bond and is bonded to the C═O group of formula (1a) or (1b).

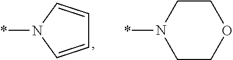

Examples of the condensed ring include the following structures. In the following structures, “*” represents a bond and is bonded to the C═O group of formula (1a) or (1b).

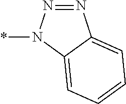 [SMILES: *n1nnc2ccccc21]

In a preferable embodiment, R¹ and R² are each independently at least one selected from a C₁₋₁₀ alkoxy group or a C₁₋₁₀ alkyl group, or R¹ and R², together with a nitrogen atom to which R¹ and R² are bonded, form a group of the following structural formula:

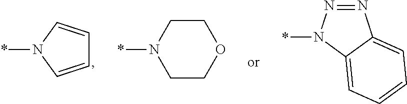

wherein * is a bond.

In another preferable embodiment, wherein one of R¹ and R² is a methyl group and the other is a methoxy group, or R¹ and R², together with a nitrogen atom to which R¹ and R² are bonded, form a group of the following structural formula:

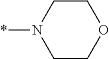 [SMILES: *N1CCOCC1]

wherein * is a bond.

In one embodiment, the compound represented by formula (1b) has two pairs of R¹ and R², both of which are monovalent organic groups.

In one embodiment, the compound represented by formula (1b) has two pairs of R¹ and R², and R¹ and R² together form a ring structure, respectively.

In one embodiment, the compound represented by formula (1b) has two pairs of R¹ and R², one pair of R¹ and R² are monovalent organic groups, and the other pair of R¹ and R² together form a ring structure.

In one embodiment, the fluoropolyether group-containing compound of the present embodiment is represented by formula (1a).

In one embodiment, the fluoropolyether group-containing compound of the present embodiment is represented by formula (1b).

In one embodiment, the compound represented by formula (1a) may be contained in an amount of 0 to 40 parts by mass, based on total 100 parts by mass of the compound represented by formula (1a) and the compound represented by formula (1b).

The fluoropolyether group-containing compound represented by formula (1a) or (1b) can be produced by combining known methods. An example of a method of the present embodiment suitable for the synthesis of the compound represented by formula (1a) or (1b) is described below as one embodiment.

The method for producing a compound represented by formula (1a) or (1b) of the present embodiment includes a step (1) of reacting a carboxylic group of the following formula (1a′) or (1b′):

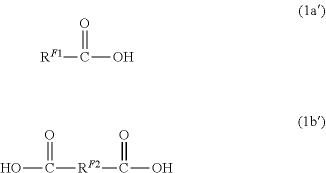

with an amine compound to synthesize a compound represented by formula (1a) or (1b):

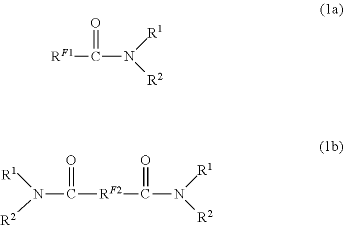

R^{F1} and R^{F2} in formulas (1a′) and (1b′) are the same as R^{F1} and R^{F2} in formulas (1a) and (1b), respectively.

The amine compound in step (1) is a compound capable of reacting with formula (1a′) or (1b′) to form a group represented by —NR¹R² in formula (1a) or (1b). R¹ and R² have the same meanings as in formulas (1a) and (1b).

More specific examples of the amine compound include N,O-dimethylhydroxylamine, pyrrole, morpholine, and benzotriazole, and salts thereof (for example, hydrochloride, sulfate, carbonate, silver salt, and various carboxylates).

Step (1) may be performed in a suitable solvent in the presence of a suitable catalyst. Examples of suitable solvent include, but are not limited to, various organic solvents such as hydrofluorocarbon, hydrochlorofluorocarbon (for example, AK-225: manufactured by AGC Inc.), chloroform, dichloromethane, acetonitrile, tetrahydrofuran (THF), dimethyl sulfoxide (DMSO), and N,N-dimethylformamide (DMF). These solvents may be used alone or in combination of two or more thereof, and are preferably used in combination of two or more thereof. When two or more solvents are used in combination, it is preferable to use, for example, at least one of highly polar solvents such as DMSO and DMF, and at least one of solvents other than the highly polar solvents such as AK-225, HFE 7200, and HFE 7300, which have appropriate solubility of organic compounds.

Examples of suitable catalysts include, but are not limited to, amine bases such as pyridine, collidine, N,N-dimethyl-4-aminopyridine (DMAP), triethylamine, and Hunig's base.

The reaction in step (1) is not limited, but may be performed, for example, at −78 to 200° C. The reaction time in step (1) is not limited, but may be, for example, 0.1 to 168 hours. The reaction pressure in step (1) is not limited, but is, for example, 0 to 100 MPa (gauge pressure), and is conveniently ambient pressure.

In step (1), a compound such as a halogenating agent such as thionyl chloride, phosphorus trichloride, phosphorus pentachloride, sulfuryl chloride, and oxalyl chloride; a dehydrating agent such as toluene sulfonic acid, trifluoromethanesulfonic acid, trifluoroacetic anhydride, trifluoromethanesulfonic acid, methanesulfonic acid, or a salt thereof (for example, a halogenated salt, preferably tosyl chloride, trifluoromethane sulfonic acid chloride, mesyl chloride or the like); and a condensing agent such as 1-[bis(dimethylamino)methylene]-1H-1,2,3-triazolo[4,5-b]pyridinium 3-oxide hexafluorophosphate (HATU), 1,1′-carbonyldiimidazole (CDI), N,N′-dicyclohexylcarbodiimide (DCC), BOP reagents such as benzotriazol-1-yloxy-trisdimethylamino phosphonium salts, 1-(3-dimethylaminopropyl)-3-ethylcarbodiimide hydrochloride (EDCI), and (1-cyano-2-ethoxy-2-oxoethylideneaminooxy)dimethyl aminomorpholinocarbenium hexafluorophosphate (COMU) can be further used.

The step (1) may be, for example, the following reaction.

From a compound represented by the following formula (1a′) or (1b′):

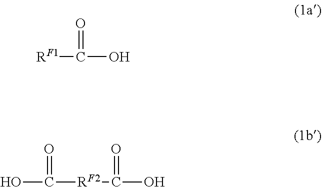

a compound represented by the following formula (1a″) or (1b″):

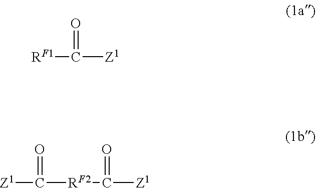

is formed (step 1-1), and
from the compound represented by the formula (1a″) or (1b″), a compound represented by the following formula (1a) or (1b):

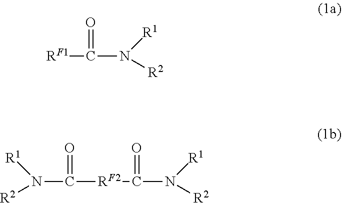

is synthesized (step 1-2).

In formulas (1a″) and (1b″), Z¹ each independently at each occurrence represents a halogen atom or an alkoxide group, preferably —F, —Cl, —Br, or —I, more preferably —Cl.

R^{F1} and R^{F2} in formulas (1a″) and (1b″) are the same as R^{F1} and R^{F2} in formulas (1a) and (1b), respectively.

Step (1-1) may be performed in a suitable solvent in the presence of a suitable catalyst. Examples of suitable solvents include, but are not limited to, fluorinated solvents such as m-xylene hexafluoride (mXHF), AK 225, HFE 7200, HFE 7300, and perfluorohexane. These solvents may be used alone or in combination of two or more.

Examples of suitable catalysts include, but are not limited to, N,N-dimethylformamide and DMAP.

The reaction in step (1-1) is not limited, but may be performed, for example, at −78 to 200° C. The reaction time in step (1-1) is not limited, but may be, for example, 0.1 to 168 hours. The reaction pressure in step (1-1) is not limited, but is, for example, 0 to 100 MPa (gauge pressure), and is conveniently ambient pressure.

In step (1-1), as the compound to be reacted with the end carboxylic acid of formula (1a′) or (1b′), for example, a halogenating agent such as thionyl chloride, phosphorus trichloride, phosphorus pentachloride, sulfuryl chloride or oxalyl chloride can be used.

Step (1-2) may be performed in a suitable solvent in the presence of a suitable catalyst. Examples of suitable solvent include, but are not limited to, various organic solvents such as hydrochlorofluorocarbon (for example, AK-225: manufactured by AGC Inc.), chloroform, dichloromethane, acetonitrile, tetrahydrofuran (THF), dimethyl sulfoxide (DMSO), and N,N-dimethylformamide (DMF). These solvents may be used alone or in combination of two or more.

Examples of suitable catalysts include, but are not limited to, amine bases such as pyridine, collidine, N,N-dimethyl-4-aminopyridine (DMAP), triethylamine, and Hunig's base.

The reaction in step (1-2) is not limited, but may be performed, for example, at −78 to 200° C. The reaction time in step (1-2) is not limited, but may be, for example, 0.1 to 168 hours. The reaction pressure in step (1-2) is not limited, but is, for example, 0 to 100 MPa (gauge pressure), and is conveniently ambient pressure.

The aldehyde group-containing compound can be formed from the compound represented by formula (1a) or formula (1b) of the present embodiment under relatively mild conditions, in particular, without the need for heating and refluxing. Furthermore, a compound having another functional group (for example, a ketone group, an alkyne group, and a vinyl group) may be formed from the compound represented by formula (1a) or formula (1b) of the present embodiment. By using the compound represented by formula (1a) or formula (1b), a compound having another functional group as described above can be formed under a mild condition, for example, an environment of 0° C. to room temperature.

It is considered that the compound of the present embodiment has a group of −c(=O)N, the reactivity of the compound may be improved, and when the compound of the present embodiment is used as a reaction raw material, the reaction can be easily controlled.

Hereinafter, fluoropolyether group-containing compounds will be described as second to fifth embodiments, and these fluoropolyether group-containing compounds are compounds that can be formed using the compound represented by formula (1a) or (1b) of the first embodiment as an intermediate.

### Second Embodiment

The present embodiment relates to a fluoropolyether group-containing compound represented by the following formula (2a) or (2b).

According to this embodiment, it is possible to provide a novel fluoropolyether group-containing compound having a plurality of carbon-carbon unsaturated bonds in the molecular structure. It enables for the compound of the present embodiment to form a compound having a various kinds of functional group. Therefore, the compound of formula (2a) or (2b) is useful as an intermediate in a synthetic reaction.

Formula (2a) or (2b):

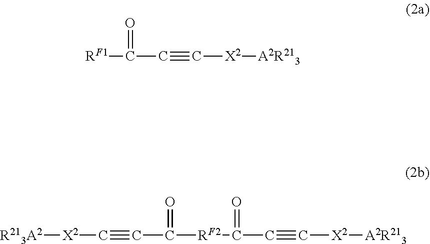

R^{F1} and R^{F2} have the same meaning as R^{F1} and R^{F2} of the first embodiment, respectively.

X² is a divalent organic group.

Preferably, X² is a C₁₋₃ alkylene group. In X², the alkylene group may be linear or branched.

In X², the C₁₋₃ alkylene group may be —CH₂—, —CH₂CH₂—, —CH₂CH₂CH₂—, —CH(CH₃)—, —CH(CH₃)CH₂—, and —CH₂CH(CH₃)—, and preferably —CH₂—.

In one embodiment, X² is optionally and each independently substituted with one or more substituents selected from a fluorine atom, a C₁₋₃ alkyl group and a C₁₋₃ fluoroalkyl group (preferably a C₁₋₃ perfluoroalkyl group).

The right side of the structure denoted as X² binds to the A².

A² is each independently at each occurrence C or Si.

In one embodiment, A² is a C atom.

In one embodiment, A² is a Si atom.

R²¹ is each independently a hydrocarbon group having at least one carbon-carbon unsaturated bond. The carbon-carbon unsaturated bond is, i.e., a carbon-carbon double bond or a carbon-carbon triple bond.

R²¹ is, for example, a group represented by —Y²¹—CH═CH—Y²², —Y²¹—CC—Y²² (wherein —CC— represents a carbon-carbon triple bond), and preferably a group represented by —Y²¹—CH═CH—Y²².

Y²¹ is a divalent organic group.

Preferably, Y²¹ is a C₁₋₃ alkylene group. In Y²¹, the alkylene group may be linear or branched.

In Y²¹, the C₁₋₃ alkylene group may be, for example, —CH₂—, —CH₂CH₂—, —CH₂CH₂CH₂—, —CH(CH₃)—, —CH(CH₃) CH₂—, and —CH₂CH(CH₃)—, and preferably —CH₂—.

Y²² is a hydrogen atom or a monovalent organic group, preferably a hydrogen atom.

In one embodiment, the fluoropolyether group-containing compound of the present embodiment is represented by formula (2a).

In one embodiment, the fluoropolyether group-containing compound of the present embodiment is represented by formula (2b).

The compound represented by formula (2a) or (2b) of the present embodiment has a plurality of carbon-carbon unsaturated bonds in the molecular chain as described above.

By having such a structure, the compound represented by formula (2a) or (2b) can be usefully used as an intermediate in a synthetic reaction. Specifically, it is possible to form a compound having a various kind of functional group from the compound of the present embodiment, because another functional group can be introduced into the carbon-carbon unsaturated bond of the compound of the present embodiment.

In one embodiment, it is possible to introduce a group having a Si atom bonded to a hydrolysable group into a carbon-carbon unsaturated bond, in particular into the carbon-carbon unsaturated bond of R²¹ of the compound of formula (2a) or (2b). Such a compound having a group containing a Si atom can be usefully used as a surface-treating agent which can be used for surface treatment of a base material, for example.

Examples of methods for synthesizing the compound represented by formula (2a) or (2b) include, but are not limited to, the following methods.

Examples of a method for synthesizing a compound represented by formula (2a) or (2b) include a method including a step (2-1) of adding, to a fluoropolyether group-containing compound represented by formula (1a) or (1b):

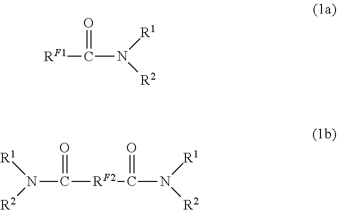

a compound represented by the following formula (2c):

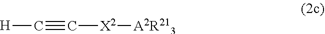

together with an organic lithium
to obtain a fluoropolyether group-containing compound represented by formula (2a) or formula (2b):

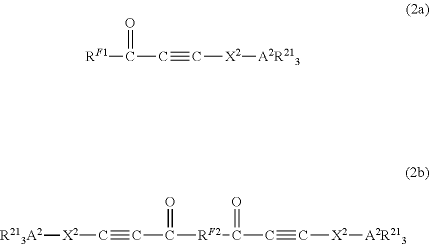

Step (2-1) is performed by using an organic lithium. Examples of the organic lithium include alkyllithium. Examples of the alkyllithium include, but are not limited to, n-butyllithium, sec-butyllithium, and tert-butyllithium.

In the present embodiment, the organic lithium and the compound represented by formula (2c) are used as described above, and a compound in which lithium is introduced into the end on the carbon-carbon triple bond side of the compound represented by formula (2c) is formed. The compound in which lithium is introduced is a compound having high nucleophilicity, and the compound represented by formula (2a) or (2b) can easily be synthesized by reacting the compound in which lithium is introduced with the compound having an amide group represented by formula (1a) or (1b).

The mixing ratio of the compound represented by formula (2c) and the organic lithium can be a ratio that can be usually used, and can be used, but not limited to, for example, in a molar ratio of 1:1 to 1:2.

Step (2-1) may be performed in a suitable solvent. Examples of suitable solvents include tetrahydrofuran, diethyl ether, HFE 7200, and HFE 7300. One of these solvents may be used singly, or two or more thereof may be used in combination.

Step (2-1) is not limited, but can be performed, for example, at −78 to 200° C. The reaction time of step (2-1) is not limited, but may be, for example, 0.1 to 168 hours. The reaction pressure in step (2-1) is not limited, but is, for example, 0 to 100 MPa (gauge pressure), and is conveniently ambient pressure.

As described above, by using the compounds of formulas (1a) and (1b), a group having a plurality of carbon-carbon unsaturated bonds can be easily introduced into the fluoropolyether group-containing compound. According to the present method, a group having a carbon-carbon unsaturated bond can be introduced under mild conditions, in particular without heating.

In formulas (2a) and (2b), R^{F1} and R^{F2} have the same meaning as R^{F1} and R^{F2} of the first embodiment, respectively.

X², A², and R²¹ in formulas (2a) and (2b) correspond X², A², and R²¹ of formula (2c), respectively.

The compound represented by formula (2c) can be synthesized from, for example, a compound represented by the following formula (2d). That is, the method may further include the following step (2-2) of synthesizing a compound represented by formula (2c).

Step (2-2) of reacting a compound represented by formula (2d):

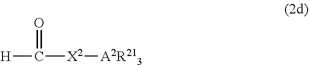

with Ohira-Bestmann reagent to synthesize a compound represented by formula (2c):

H—C≡C—X²-A²R²¹₃ (2c)

The Ohira-Bestmann reagent in step (2-2) is dimethyl (1-diazo-2-oxopropyl)phosphonate.

Step (2-2) may be performed in a suitable solvent in the presence of a suitable catalyst. Examples of suitable solvents include, but are not limited to, various organic solvents such as methanol, THF, and dioxane. These solvents may be used alone or in combination of two or more.

Examples of suitable catalysts include, but are not limited to, strong bases such as potassium carbonate, sodium carbonate, potassium tert-butoxide (t-BuOK), and butyllithium (BuLi), and amine bases such as diazabicycloundecene, diazabicyclononene (DBN), triethylamine, and Hunig's base.

In the fluoropolyether group-containing compound represented by formula (2a) or (2b), for example, when R²¹ is represented by —Y²¹—CH═CH—Y²² and Y²² is a hydrogen atom, the fluoropolyether group-containing compound represented by formula (2a) or (2b) can be hydrosilylated to form a compound having a SiR^{hx} (R^{hx} is a hydrolyzable group) at the molecular end. Such a compound can be usefully used as a surface-treating agent which can be used for surface treatment of a base material, for example.

In another embodiment, the fluoropolyether group-containing compound represented by formula (2a) or (2b) can undergo a cyclization reaction to form a compound represented by formula (2e) or (2f), for example.

Specifically, the carbonyl group C═O of formula (2a) or (2b) can be reacted with hydroxylamine hydrochloride or the like to form a group represented by C═N—OH, followed by a condensation reaction to form a compound represented by formula (2e) or (2f).

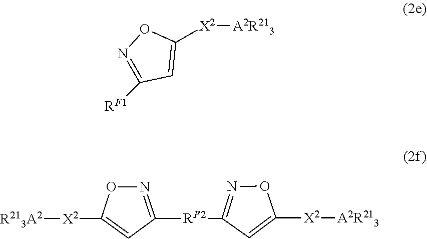

In the fluoropolyether group-containing compound represented by the formula (2e) or (2f), for example, when R²¹ is represented by —Y²¹—CH═CH—Y²² and Y²² is a hydrogen atom, compound having a SiR^{hx} (R^{hx} is a hydrolyzable group) at the molecular end can be formed by hydrosilylation. Such a compound can be usefully used as a surface-treating agent which can be used for surface treatment of a base material, for example.

### Third Embodiment

The present embodiment relates to a fluoropolyether group-containing compound represented by the following formula (4a) or (4b).

According to the present embodiment, it is possible to provide a fluoropolyether group-containing compound having an aldehyde end in the molecular structure. It is possible to form a compound having a various kinds of functional group from the compound of the present embodiment.

Formula (4a) or (4b)

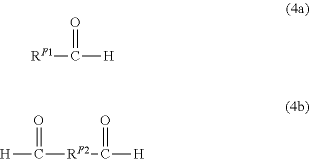

In the formulas, R^{F1} and R^{F2} have the same meaning as R^{F1} and R^{F2} of the first embodiment, respectively.

The compound represented by formula (4a) or (4b) of the present embodiment has an aldehyde group as described above. By having an aldehyde group, it enables to form a compound having a various kind of functional group from the compound of the present embodiment. Therefore, by having such a structure, the compound represented by formula (4a) or (4b) is useful as an intermediate in a synthetic reaction.

In one embodiment, the fluoropolyether group-containing compound of the present embodiment is represented by formula (4a).

In one embodiment, the fluoropolyether group-containing compound of the present embodiment is represented by formula (4b).

In one embodiment, the compound represented by formula (4a) or (4b) may be, for example, a precursor of the compound represented by formula (3a) or (3b) of the fourth embodiment.

In one embodiment, the compound represented by formula (4a) or (4b) may be a precursor of a compound of the following formula (4c) or (4d). R^{F1} and R^{F2} in formulas (4c) and (4d) are the same as R^{F1} and R^{F2} in formulas (4a) and (4b), respectively.

R^{F1}—CH═CH₂ (4c)

CH₂═CH—R^{F2}—CH═CH₂ (4d)

Examples of methods for synthesizing the compound represented by formula (4a) or (4b) include, but are not limited to, the following methods.

Specifically, the compound represented by formula (4a) or formula (4b) can be synthesized by a method including a step of reducing the compound represented by formula (1a) or (1b) of the first embodiment:

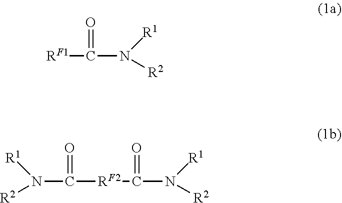

in the presence of a catalyst to obtain a fluoropolyether group-containing compound represented by formula (4a) or formula (4b):

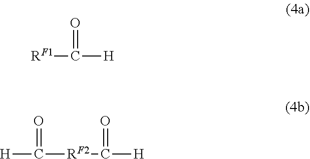

In formulas (4a) and (4b), R^{F1} and R^{F2} have the same meaning as R^{F1} and R^{F2} of the first embodiment, respectively.

The above step may be performed in a suitable solvent in the presence of a suitable catalyst. Examples of suitable catalysts include, but are not limited to, diisobutylaluminum hydride and lithium aluminum hydride (LAH). Examples of suitable solvents include, but are not limited to, fluorinated solvents such as HFE 7200 and HFE 7300; non-fluorinated solvents such as THF and diethyl ether; or mixed solvents containing two or more of these. It is preferable to use two or more kinds of the above solvents in combination.

The step is not limited, but may be performed, for example, at −78 to 200° C. The reaction time in the step is not limited, but may be, for example, 0.1 to 168 hours. The reaction pressure in the step is not limited, but is, for example, 0 to 100 MPa (gauge pressure), and is conveniently ambient pressure.

As described above, by using the compounds represented by formulas (1a) and (1b), an aldehyde group can be easily introduced into the fluoropolyether group-containing compound. According to the present method, an aldehyde group can be introduced under mild conditions, in particular without heating.

### Fourth Embodiment

The present embodiment relates to a fluoropolyether group-containing compound represented by the following formula (3a) or (3b).

According to the present embodiment, it is possible to provide a novel fluoropolyether group-containing compound having a carbon-carbon triple bond in the molecular end. It enables to form a compound having a various kind of functional group from the compound of the present embodiment. Formula (3a) or (3b):

R^{F1}—C≡C—H (3a)

H—C≡C—R^{F2}—C≡C—H (3b)

In the formulas, R^{F1} and R^{F2} have the same meaning as R^{F1} and R^{F2} of the first embodiment, respectively.

The compound represented by formula (3a) or (3b) of the present embodiment has an alkyne at an end portion of the compound as described above. By having such a structure, it enables to form a compound having a various kind of functional group from the compound represented by formula (3a) or (3b). The compound represented by formula (3a) or (3b) can be useful as an intermediate in a synthetic reaction.

In one embodiment, the fluoropolyether group-containing compound of the present embodiment is represented by formula (3a).

In one embodiment, the fluoropolyether group-containing compound of the present embodiment is represented by formula (3b).

In one embodiment, the compound represented by formula (3a) or (3b) may be a precursor of a compound represented by the following formula (3c) or (3d). Specifically, the compound represented by the following formula (3c) or (3d) can be synthesized by reacting the compound represented by formula (3a) or (3b) with a compound represented by N₃X²A²R²¹₃.

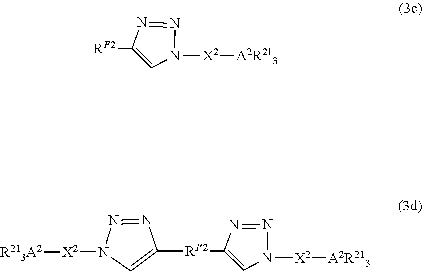

R^{F1} and R^{F2} in formulas (3c) and (3d) are the same as R^{F1} and R^{F2} in formulas (3a) and (3b). X², A², and R²¹ in formulas (3c) and (3d) have the same meaning as X², A², and R²¹ in formulas (2a) and (2b).

Furthermore, in the compound represented by formula (3c) or (3d), for example, when R²¹ is represented by —Y²¹—CH═CH—Y²² and Y²² is a hydrogen atom, the fluoropolyether group-containing compound represented by formula (3c) or (3d) can be hydrosilylated to form a compound having a SiR^{hx} (R^{hx} is a hydrolyzable group) at the molecular end. Such a compound can be used as a surface-treating agent which can be used for surface treatment of a base material, for example.

Examples of methods for synthesizing the compound represented by formula (3a) or (3b) of the present embodiment include, but are not limited to, the following methods.

Specifically, the compound represented by formula (3a) or formula (3b) can be synthesized by a method including a step of reacting a compound represented by formula (4a) or (4b):

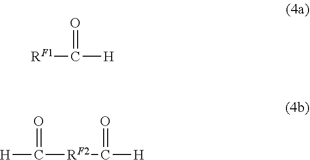

with Ohira-Bestmann reagent to obtain a fluoropolyether group-containing compound represented by formula (3c) or formula (3b):

R^{F1}—C≡C—H (3a)

H—C≡C—R^{F2}—C≡C—H (3b)

R^{F1} and R^{F2} in formulas (3a) and (3b) are the same as R^{F1} and R^{F2} in formulas (4a) and (4b), respectively.

The step may be performed in a suitable solvent. Examples of suitable solvents include, but are not limited to, fluorinated solvents such as HFE 7200 and HFE 7300; non-fluorinated solvents such as THF and diethyl ether; and mixed solvents containing two or more of these.

The step is not limited, but may be performed, for example, at −78 to 200° C. The reaction time in the step is not limited, but may be, for example, 0.1 to 168 hours. The reaction pressure in the step is not limited, but is, for example, 0 to 100 MPa (gauge pressure), and is conveniently ambient pressure.

As described above, by using the compounds represented by formulas (1a) and (1b), a carbon-carbon triple bond can be easily introduced into the end of the fluoropolyether group-containing compound. According to the present method, a carbon-carbon triple bond can be introduced under mild conditions, in particular without heating.

### Fifth Embodiment

The present embodiment relates to a fluoropolyether group-containing compound represented by the following formula (5a) or (5b).

According to the present embodiment, it is possible to provide a fluoropolyether group-containing compound having a carbon-carbon double bond in the molecular structure. It enables to form a compound having a various kind of functional group from the compound of the present embodiment.

Formula (5a) or (5b)

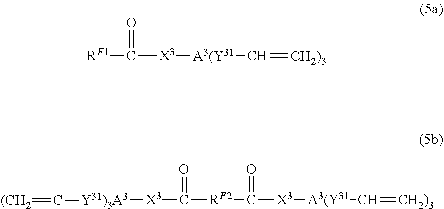

In the formulas, R^{F1} and R^{F2} have the same meaning as R^{F1} and R^{F2} of the first embodiment, respectively.

In the formula, X³ is a divalent organic group.

Preferably, X³ is a C₁₋₃ alkylene group. In X³, the C₁₋₃ alkylene group may be linear or branched.

In X³, the C₁₋₃ alkylene group may be —CH₂—, —CH₂CH₂—, —CH₂CH₂CH₂—, —CH(CH₃)—, —CH(CH₃)CH₂—, and —CH₂CH(CH₃)—, and preferably —CH₂CH₂—.

In one embodiment, X³ is optionally and each independently substituted with one or more substituents selected from a fluorine atom, a C₁₋₃ alkyl group and a C₁₋₃ fluoroalkyl group (preferably, a C₁₋₃ perfluoroalkyl group).

The right side of the structure denoted as X³ binds to the A³.

A³ is each independently at each occurrence C or Si.

In one embodiment, A³ is a C atom.

In one embodiment, A³ is a Si atom.

Y³¹ is a divalent organic group.

Preferably, Y³¹ is a C₁₋₃ alkylene group. In Y³¹, the alkylene group may be linear or branched.

In Y³¹, the C₁₋₃ alkylene group may be —CH₂—, —CH₂CH₂—, —CH₂CH₂CH₂—, —CH(CH₃)—, —CH(CH₃)CH₂—, and —CH₂CH(CH₃)—, and preferably —CH₂—.

The left side of the structure denoted as Y³¹ binds to the A³.

In one embodiment, the fluoropolyether group-containing compound of the present embodiment is represented by formula (5a).

In one embodiment, the fluoropolyether group-containing compound of the present embodiment is represented by formula (5b).

The compound represented by formula (5a) or (5b) of the present embodiment has a carbon-carbon double bond at the molecular end as described above.

By having such a structure, the compound represented by formula (5a) or (5b) can be usefully used as an intermediate in a synthetic reaction. Specifically, it is possible to form a compound having a various kind of functional group from the compound of the present embodiment, because another functional group can be introduced into the carbon-carbon double bond of the compound of the present embodiment.

In one embodiment, the compound represented by formula (5a) or (5b) may incorporate a group comprising a Si atom bonded to a hydrolysable group into a carbon-carbon double bond. Such a compound having a group containing a Si atom can be usefully used as a surface-treating agent which can be used for surface treatment of a base material, for example.

Examples of methods for synthesizing the compound represented by formula (5a) or (5b) include, but are not limited to, the following methods.

Examples of a method for synthesizing a compound represented by formula (5a) or (5b) include a method including a step (5-1) of reacting a fluoropolyether group-containing compound represented by formula (1a) or (1b):

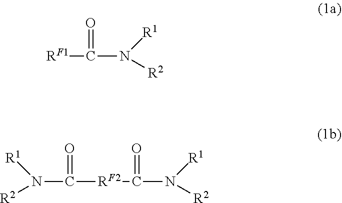

with a compound represented by the following formula (5c):

Hal Mg—X³-A³(Y³¹—CH═CH₂)₃ (5c)

Step (5-1) may be performed in a suitable solvent. Examples of suitable solvents include tetrahydrofuran, diethyl ether, HFE 7200, and HFE 7300. One of these solvents may be used singly, or a plurality kinds thereof may be used in combination.

Step (5-1) is not limited, but can be performed, for example, at −78 to 200° C. The reaction time of step (5-1) is not limited, but may be, for example, 0.1 to 168 hours. The reaction pressure in step (5-1) is not limited, but is, for example, 0 to 100 MPa (gauge pressure), and is conveniently ambient pressure.

As described above, by using the compounds represented by formulas (1a) and (1b), a carbon-carbon double bond can be easily introduced into the end of the fluoropolyether group-containing compound. According to the present method, a carbon-carbon double bond can be introduced under mild conditions, in particular without heating.

In formula (5c), X³, A³, and Y³¹ are the same as X³, A³, and Y³¹ in formulas (5a) and (5b), respectively.

In formula (5c), Hal represents a halogen atom. The halogen atoms are, i.e., F, Cl, Br, and I, preferably Br.

Embodiments have been described above, but it will be understood that various modifications can be made to embodiments and details without departing from the spirit and the scope of the claims.

The present disclosure provides [1] to [14] below.
[1]A fluoropolyether group-containing compound of formula (1a) or formula (1b):

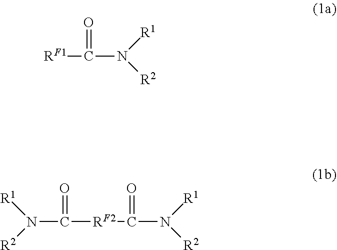

wherein
   R^{F1} is each independently at each occurrence Rf¹—R^{F}—O_{q}—;
   R^{F2} is —Rf²ₚ-R^{F}—O_{q}—;
   Rf¹ is each independently at each occurrence a C₁₋₁₆ alkyl group optionally substituted with one or more fluorine atoms;
   Rf² is a C₁₋₆ alkylene group optionally substituted with one or more fluorine atoms;
   R^{F} is each independently at each occurrence a divalent fluoropolyether group;
   p is 0 or 1;
   q is each independently at each occurrence 0 or 1; and
   R¹ and R², each independently at each occurrence, are an optionally substituted monovalent organic group, or together form a group having an optionally substituted heterocyclic ring structure.
[2] The fluoropolyether group-containing compound according to [1], wherein R^{F} is each independently at each occurrence a group represented by formula:

(OC₆F₁₂)ₐ—(OC₅F₁₀)_{b}—(OC₄F₈)_{c}—(OC₃F₆)_{d}—(OC₂F₄)ₑ—(OCF₂)_{f}—
wherein
   a, b, c, d, e and f are each independently an integer of 0 to 200, the sum of a, b, c, d, e and f is 1 or more, and the occurrence order of the respective repeating units enclosed in parentheses provided with a, b, c, d, e or f is not limited in the formula.
[3] The fluoropolyether group-containing compound according to [1] or [2], wherein R¹ and R², each independently at each occurrence, are an optionally substituted or unsubstituted monovalent organic group having 1 to 10 carbon atoms, or together form a group having a heterocyclic ring structure, wherein the ring structure contains 2 to 10 carbon atoms.
[4] The fluoropolyether group-containing compound according to any one of [1] to [3], wherein R¹ and R², each independently at each occurrence, are an alkyl group or an alkoxy group having 1 to 10 carbon atoms, or together form a group having a ring structure which is a 5 to 10-membered heterocyclic ring, or together form a group having a ring structure which is a condensed ring containing a 5 to 10-membered heterocyclic ring, wherein the alkyl group, the alkoxy group and the group having the ring structure may be substituted.
[5] The fluoropolyether group-containing compound according to any one of [1] to [4], wherein R¹ and R², each independently at each occurrence, are a C₁₋₁₀ alkyl group or a C₁₋₁₀ alkoxy group, together form a group having a ring structure, wherein the ring structure is a 5 to 10-membered heterocyclic ring, or together form a group having a condensed ring, wherein the condensed ring contains a 5 to 10-membered heterocyclic ring and a 3 to 10-membered ring other than the heterocyclic ring.
[6] The fluoropolyether group-containing compound according to any one of [1] to [5], wherein
   R¹ and R², each independently, are a C₁₋₁₀ alkoxy group or a C₁₋₁₀ alkyl group, or
   R¹ and R², together with a nitrogen atom to which they are bonded, form a group of the following formula:

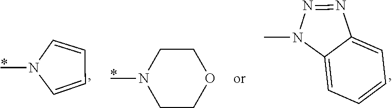

wherein * is a bond.
[7] The fluoropolyether group-containing compound according to any one of [1] to [6], wherein
   one of R¹ and R² is a methyl group and the other is a methoxy group, or
   R¹ and R², together with a nitrogen atom to which R¹ and R² are bonded, form a group of the following formula:

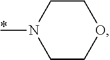

wherein * is a bond.
[8]A method for producing a fluoropolyether group-containing compound comprising:
the compound of formula (1a) or (1b) according to [1] and a compound of the following formula (2c):

H—C≡C—X²-A²R²¹₃ (2c)
are added with an organic lithium to obtain the fluoropolyether group-containing compound of formula (2a) or formula (2b):

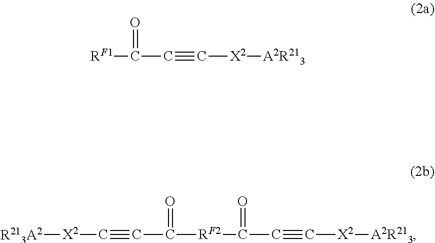

wherein
in formula (2c),
   X² is a divalent organic group;
   A² is each independently at each occurrence C or Si; and
   R²¹ is each independently a hydrocarbon group having at least one carbon-carbon double bond,
in formula (2a) or formula (2b),
   R^{F1} and R^{F2} have the same meaning as [1];
   X², A², and R²¹ are the same as X², A², and R²¹ of formula (2c), respectively.
[9]A fluoropolyether group-containing compound of formula (2a) or formula (2b):

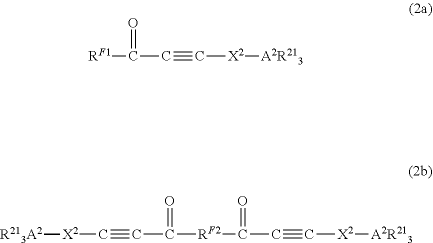

wherein
   R^{F1} and R^{F2} have the same meaning as [1];
   X² is a divalent organic group;
   A² is each independently at each occurrence C or Si; and
   R²¹ is a hydrocarbon group having at least one carbon-carbon unsaturated bond.
[10]A method for producing a fluoropolyether group-containing compound comprising reducing the compound of formula (1a) or (1b) according to [1] in the presence of an alkyllithium to obtain the fluoropolyether group-containing compound of formula (4a) or formula (4b):

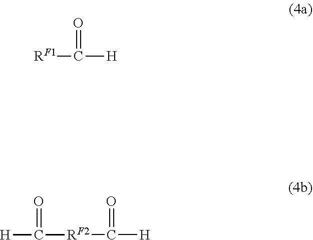

wherein R^{F1} and R^{F2} have the same meaning as [1].
[11]A fluoropolyether group-containing compound of formula (4a) or formula (4b)

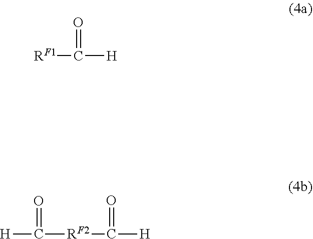

wherein R^{F1} and R^{F2} have the same meaning as [1].
[12]A method for producing a fluoropolyether group-containing compound comprising reacting a fluoropolyether group-containing compound of formula (4a) or (4b):

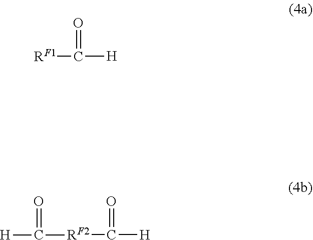

with dimethyl (1-diazo-2-oxopropyl)phosphonate to obtain the fluoropolyether group-containing compound of formula (3a) or formula (3b):

R^{F1}—C≡C—H (3a)

H—C≡C—R^{F2}—C≡C—H (3b)
wherein R^{F1} and R^{F2} have the same meaning as [1].
[13]A fluoropolyether group-containing compound of formula (3a) or formula (3b):

R^{F1}—C≡C—H (3a)

H—C≡C—R^{F2}—C≡C—H (3b)
wherein R^{F1} and R^{F2} have the same meaning as [1].
[14]A fluoropolyether group-containing compound of formula (5a) or formula (5b):

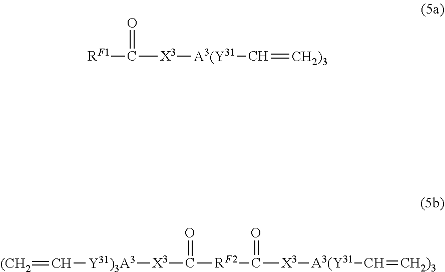

wherein
   R^{F1} and R^{F2} have the same meaning as [1];
   X³ is a divalent organic group;
   A³ is each independently at each occurrence C or Si; and
   Y³¹ is a divalent organic group.

### EXAMPLES

Hereinafter, the present disclosure will be described with reference to, but is not limited to, Examples. In this Examples, all the chemical formulas shown below represent average compositions, “Me” represents CH₃, and “Boc” represents a tert-butoxycarbonyl group.

### (Example 1) Synthesis of Weinreb Amide

To 18 mL of simply dehydrated m-xylene hexafluoride (mXHF), 10.9 g (2.73 mmol) of CF₃CF₂CF₂ (OCF₂CF₂CF₂)ₙOCF₂CF₂COOH (n is 25) was dissolved, and then 40 μl (0.514 mmol) of dimethylformamide (DMF) and 1.4 mL (19.3 mmol) of thionyl chloride were sequentially added to the solution, followed by stirring at room temperature for 10 minutes. Thereafter, the container containing the reaction solution was placed in an oil bath and stirred at 100° C. for 5 hours. After 5 hours, the resulting reaction solution was concentrated to dryness to obtain the acid chloride CF₃CF₂CF₂(OCF₂CF₂CF₂)ₙOCF₂CF₂COCl.

The acid chloride thus obtained was dissolved in a mixed solvent of 16 mL of simply dehydrated AK 225 (manufactured by AGC Inc.) and 6 mL of dehydrated chloroform, and a hydrochloride salt of N,O-dimethylhydroxyamine was added to this solution. Subsequently, at room temperature, 2.7 mL (33.5 mmol) of pyridine was added dropwise over 10 minutes, and the above solution was stirred at 60° C. for 2 days. After 2 days, the resulting reaction solution was washed twice with 10 mL of 1 N HCl followed by one wash with 10 mL of water. The washed reaction solution was filtered through a Kiriyama funnel packed with silica gel in 2 cm, and the filtrate was concentrated to dryness. The product obtained by concentration to dryness was dissolved in 10 mL of AK 225, and the solution was then filtered through a filter. The filtrate was concentrated to dryness to obtain 10.15 g of Weinreb amide represented by the following formula (yield 93%).

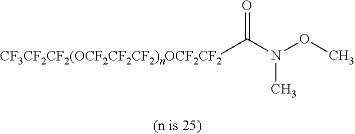

¹H NMR (mXHF, 400 MHz) δ: 3.55 (s, 3H), 4.06 (s, 3H);

¹⁹F NMR (mXHF, 400 MHz) δ: −84.14-−84.16, −85.60-−85.89, −86.60, −120.44, −131.39-−131.49, −132.40

### (Example 2) Synthesis of Morpholine Amide

To 2.2 g (0.55 mmol) of a methyl ester represented by CF₃CF₂CF₂ (OCF₂CF₂CF₂)ₙOCF₂CF₂COOCH₃ (n is 25), 0.479 g (5.5 mmol) of morpholine was added, and the mixture was stirred for 30 minutes under reduced pressure. Then, the mixture was stirred at room temperature for 3 days in 3 mL of simplified dehydrated AK 225. After 3 days, the resulting reaction solution was washed with 10 mL of 3.5 N HCl followed by one wash with 10 mL of water. After washing with water, the product was dried using 20 g of sodium sulfate, and then filtered through a Kiriyama funnel. The filtrate was concentrated to dryness to obtain 2.274 g of morpholine amide represented by the following formula (yield: 100%).

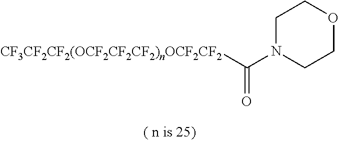

¹H NMR (mXHF, 400 MHz) δ: 3.95 (m, 4H), 3.99 (m, 4H);

¹⁹F NMR (mXHF, 400 MHz) δ: −84.13-−84.17, −85.00-−86.50, −86.93, −116.94, −131.39-−131.50, −132.41.

### Example 3

### (Synthesis Example 3-1) Synthesis of Aldehyde

To 10 mL of simply dehydrated hydrofluoroether (Novec HFE-7200, manufactured by 3M), 4.54 g (1.14 mmol) of Weinreb amide obtained in Example 1 was dissolved, and then the reaction solution was cooled to −78° C. Subsequently, 2.38 mL (2.38 mmol) of 1 mol/L diisobutylaluminum hydride (DIRAL-H) was slowly added dropwise over 30 minutes, and then the reaction solution was stirred for 8.5 hours while being naturally warmed from −78° C. to room temperature. After 8.5 hours, 10 mL of 1N HCl was added to the reaction solution, and after stirring for 30 minutes, the aqueous phase was removed by separation.

Thereafter, HFE 7200 phase was washed with 10 mL of water and 10 mL of saturated saline and dried with 30 g of sodium sulfate thereafter. Subsequently, the dried HFE 7200 solution was filtered using a Kiriyama funnel and then concentrated to dryness. In 10 mL of perfluorohexane, 4.9 g of the product obtained by concentration to dryness was dissolved, and the solution was washed with 10 mL of 1N HCl and 10 mL of water in this order. Subsequently, the perfluorohexane solution was washed with 10 mL of methanol and 10 mL of chloroform in this order. The washed perfluorohexane solution was concentrated to dryness to obtain 4.39 g of aldehyde represented by the following formula (yield 97%).

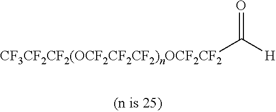

¹⁹F NMR (mXHF, 400 MHz) δ: −83.62-−83.70, −84.12-−84.26, −85.45-−85.97, −86.58-−86.73, −128.16-−128.27, −128.51-−128.61, −131.48-−132.00, −132.40

### (Synthesis Example 3-2) Synthesis of Alkynes

In a mixed solvent of 3 mL of simply dehydrated HFE 7200 and 1.5 mL of dehydrated methanol, 2 g (0.5 mmol) of aldehyde obtained in Synthesis Example 3-1 was dissolved, and then 0.306 g (2.22 mmol) of potassium carbonate was added thereto. Subsequently, 0.2 ml (1.33 mmol) of Ohira-Bestmann reagent was added and stirred overnight at room temperature. The next morning, 20 mL of perfluorohexane was added to the reaction solution, and the mixture was washed twice with 10 mL of chloroform. The washed reaction solution was filtered using a Kiriyama funnel packed with silica gel in 2 cm, and the filtrate was concentrated to dryness to obtain 2 g of alkyne represented by the following formula (yield: 100%).

CF₃CF₂CF₂(OCF₂CF₂CF₂)ₙOCF₂CF₂C≡CH

(n is 25)

¹H NMR (mXHF, 400 MHz) δ: 3.16 (t, 1H);

¹⁹F NMR (mXHF, 400 MHz) δ: −84.12-−84.16, −85.59-−85.96, −86.90, −89.99, −105.58, −131.40-−131.63, −132.39

### Synthesis Example 3-3

After suspending 3.92 g (60.3 mmol) of sodium azide in 6 mL of dehydrated acetonitrile, the reaction solution was cooled to 0° C. After cooling, 1.4 mL (13.3 mmol) of trifluoromethanesulfonyl chloride was added dropwise to the solution over 10 minutes, and the solution was stirred in an ice bath for 3 hours. After 3 hours, 20 mL of dichloromethane and 10 mL of water was added to the reaction solution and stirred for 5 minutes. After 5 minutes, the dichloromethane phase was extracted and washed again with 10 mL of water to obtain a dichloromethane solution of trifluoromethanesulfonyl azide.

After dissolving 1.1 g (6.65 mmol) of H₂NCH₂C(CH₂CH═CH₂)₃ and 1.38 g (9.98 mmol) of potassium carbonate in a mixed solvent of 40 mL of methanol and 20 mL of water, 0.166 g (0.665 mmol) of copper sulfate pentahydrate was added thereto. Subsequently, a dichloromethane solution of the trifluoromethanesulfonyl azide synthesized above was added dropwise to the solution over 10 minutes, and the solution was stirred at room temperature for 2 hours. After 2 hours, the reaction solution was washed with 10 mL of saturated aqueous ammonium chloride solution and 10 mL of water, and concentrated to dryness. The product obtained by concentration to dryness was dissolved in a mixed solvent of 1 mL of ethyl acetate and 10 mL of hexane, and the solution was filtered through a Kiriyama funnel packed with silica gel in 2 cm, and the filtrate was concentrated to dryness to obtain 1.06 g of a compound represented by the following formula (yield: 84%).

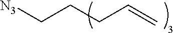

¹H NMR (CDCl₃, 400 MHz) δ: 2.00-2.05 (m, 6H), 3.16 (s, 2H), 4.90-5.15 (m, 6H), 5.73-5.90 (m, 3H)

### (Synthesis Example 3-4) Synthesis of Triazole

In a mixed solvent containing 3 mL of AK 225, 1.5 mL of dimethyl sulfoxide (DMSO), and 0.5 mL of water, 1.3827 g (0.346 mmol) of the alkyne obtained in Synthesis Example 3-2 was dissolved. To the resulting solution was added 0.132 g (0.691 mmol) of the compound obtained in Synthesis Example 3-3, 0.0137 g (0.0691 mmol) of sodium L-ascorbate, and 0.0086 g (0.0346 mmol) of copper sulfate pentahydrate in this order, and the mixture was stirred at room temperature overnight. The next morning, 10 mL of AK 225 was added to the reaction solution, washed with 10 mL of water, and concentrated to dryness. The product obtained by concentration to dryness was dissolved in 20 mL of perfluorohexane, washed twice with 10 mL of chloroform, and dried using 10 g of sodium sulfate. Subsequently, the solution was filtered through a Kiriyama funnel, and the filtrate was concentrated to dryness and purified by flash column chromatography using silica gel to obtain 0.883 g of triazole represented by the following formula (yield: 64%).

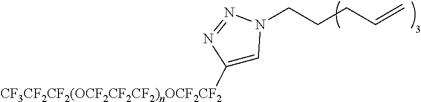

(n is 25)

¹H NMR (mXHF, 400 MHz) δ: 2.35-2.40 (m, 6H), 4.57 (s, 2H), 5.42-5.54 (m, 6H), 6.16-6.27 (m, 3H)

¹⁹F NMR (mXHF, 400 MHz) δ: −84.12-−84.16, −85.50-−86.00, −86.58, -−86.59, −89.04-−89.11, −114.53, −131.39-−131.96, −132.39

### (Synthesis Example 3-5) Hydrosilylation of Triazole

In 1.2 mL of simply dehydrated mXHF, 0.883 g (0.221 mmol) of triazole obtained in Synthesis Example 3-4 was dissolved, and then 60 μl (0.277×10⁻² mmol) of Karstedt catalyst and 10 μl (0.11 mmol) of aniline were added thereto in this order. After stirring at room temperature for 30 minutes, 0.2 mL (1.57 mmol) of trimethoxysilane was added to the reaction solution and stirred at room temperature for 2 hours. After 2 hours, 1.5 mL of simply dehydrated HFE 7200 was added. To the reaction solution was added 0.04 g of activated carbon and stirred at room temperature for 30 minutes. After 30 minutes, filter filtration was performed, and the filtrate was concentrated to dryness to obtain 0.93 g of hydrosilyl triazole represented by the following formula (yield: 100%).

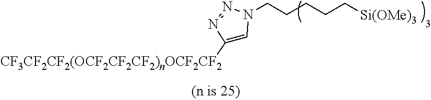

(n is 25)

¹H NMR (mXHF, 400 MHz) δ: 0.96-1.00 (m, 6H), 1.55-1.65 (m, 6H), 1.90-1.98 (m, 6H), 4.57 (s, 2H)

¹⁹F NMR (mXHF, 400 MHz) δ: −84.14-−84.16, −85.50-−86.00, −86.58, -−86.59, −88.59-−88.64, −114.50-−114.30, −131.39-−131.96, −132.39

### Synthesis Example 4

### (Synthesis Example 4-1) Synthesis of Vinyl

After 0.263 g (0.65 mmol) of methyltriphenylphosphonium iodide was dissolved in 3 mL of dehydrated tetrahydrofuran (THF), 0.073 g (0.65 mmol) of potassium tert-butoxide (t-BuOK) was added thereto, and the mixture was stirred at room temperature for 1 hour. After 1 hour, 1.3 g (0.325 mmol) of the aldehyde obtained in Synthesis Example 3-1 was added and stirred at room temperature overnight. The next morning, 20 mL of perfluorohexane was added to the reaction solution, washed twice with 10 mL of water, and then washed with 10 mL of methanol. Subsequently, the reaction solution was washed twice with 10 mL of chloroform, filtered through a Kiriyama funnel packed with silica gel in 2 cm, and extracted with 60 mL of perfluorohexane. Finally, the solution was concentrated to dryness to obtain 0.851 g of vinyl represented by the following formula (yield: 66%).

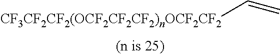

(n is 25)

¹H NMR (mXHF, 400 MHz) δ: 6.00-6.03 (m, 1H), 6.28 (d, 2H);

¹⁹F NMR (mXHF, 400 MHz) δ: −84.13, −85.60-−86.00, −86.50, −120.26, −131.40-−131.89, −132.40.

### Example 5

### Synthesis Example 5-1

After suspending 3.6 g (21.7 mmol) of HOCH₂C(CH₂CH═CH₂)₃ and 36 g of activated molecular sieves 4 A in 50 mL of dichloromethane, 12.21 g (32.5 mmol) of pyridinium dichromate (PDC) was added in three portions. After stirring for 5 hours at room temperature, the solution was filtered using a Kiriyama funnel packed with silica gel in 2 cm, and the filtrate was concentrated to dryness to obtain 3.47 g of a compound represented by the following formula (yield: 98%).

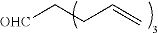

¹H NMR (CDCl₃, 400 MHz) δ: 2.26-2.29 (m, 6H), 5.00-5.11 (m, 6H), 5.66-5.80 (m, 3H), 9.52 (s, 1H).

### (Synthesis Example 5-2) Synthesis of Methoxy Compound

In 60 mL of tetrahydrofuran (THF), 17.5 g (51.1 mmol) of methoxymethyltriphenylphosphonium chloride was dissolved. Thereafter, 6.5 g (58.0 mmol) of potassium tert-butoxide (t-BuOK) was added and the solution was stirred at room temperature for 1 hour. After 1 hour, 5.6 g (34.1 mmol) of the compound obtained in Synthesis Example 5-1 was added and the solution was stirred at room temperature for 4 hours. After 4 hours, 120 mL of ethyl acetate was added to the reaction solution, washed twice with 40 mL of water, and dried with 30 g of sodium sulfate. The dried solution was then filtered through a Kiriyama funnel, and the filtrate was concentrated to dryness. Thereafter, the mixture was purified by flash column chromatography using silica gel to obtain 6.26 g of a methoxy compound (E form is represented by the following formula) as a mixture of an E form and a Z form (yield: 95%).

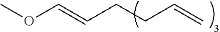

¹H NMR (CDCl₃, 400 MHz) δ: 2.05-2.09 (m, 6H), 2.20-2.25 (m, 6H), 3.50-3.54 (m, 6H), 3.99-4.02 (m, 1H), 4.60-4.67 (m, 1H), 5.00-5.10 (m, 12H), 5.75-5.80 (m, 6H), 6.15-6.19 (m, 1H)

### (Synthesis Example 5-3) Synthesis of Aldehyde

In 6 mL of THF, 1.26 g (6.55 mmol) of the methoxy compound obtained in Synthesis Example 5-2 was dissolved, 3 mL of 6N HCl was added thereto, and the solution was stirred at room temperature for 7 hours. After 7 hours, to the reaction solution was added 20 mL of a mixed solution of ethyl acetate and hexane (ethyl acetate:hexane=1:4), washed twice with 100 mL of water, and dried using 20 g of sodium sulfate. Subsequently, the dried solution was filtered through a Kiriyama funnel, and the filtrate was concentrated to dryness to obtain 1.04 g of a compound represented by the following formula in which the number of carbon atoms was increased by one (yield: 97%).

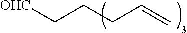

¹H NMR (CDCl₃, 400 MHz) δ: 2.15-2.17 (m, 6H), 2.30 (s, 2H), 5.00-5.13 (m, 6H), 5.76-5.90 (m, 3H), 9.84 (s, 1H)

### (Synthesis Example 5-4) Synthesis of Carboxylic Acid

In 10 mL of dehydrated methanol, 0.59 g (3.31 mmol) of the compound obtained in Synthesis Example 5-3 was dissolved, 2.02 g (14.6 mmol) of potassium carbonate and 1.09 mL (7.29 mmol) of Ohira-Bestmann reagent were added thereto in this order, and the mixture was stirred at room temperature for 3 hours. After 3 hours, 20 mL of diethyl ether was added to the reaction solution, washed twice with 100 mL of water, washed with 10 mL of saturated saline, and dried over 20 g of sodium sulfate. The solution was then filtered through a Kiriyama funnel, and the filtrate was concentrated to dryness. The residue was dissolved in 40 mL of hexane, and the solution was filtered through a Kiriyama funnel packed with silica gel in 3 cm, and the filtrate was concentrated to dryness to obtain 0.6 g of a compound represented by the following formula (yield: 100%).

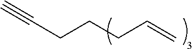

¹H NMR (CDCl₃, 400 MHz) δ: 1.99 (s, 1H), 2.00-2.15 (m, 8H), 5.00-5.20 (m, 6H), 5.75-5.85 (m, 3H)

### (Synthesis Example 5-5) Synthesis of Alkynone

In 3 mL of dehydrated THF, 0.2 g (1.15 mmol) of the compound obtained in Synthesis Example 5-4 was dissolved, the solution was immersed in an ice bath containing dry ice and acetone, and the internal temperature was cooled to −78° C. After cooling, 0.795 mL (1.32 mmol) of n-BuLi (1.66 mol/L) was added dropwise to the solution over 10 minutes, and the solution was stirred for 1 hour with a natural warming. After 1 hour, the internal temperature was cooled again to −78° C., and a solution in which 2.3 g (0.574 mmol) of Weinreb amide obtained in Example 1 was dissolved in 2 mL of simply dehydrated HFE 7200 was added dropwise over 5 minutes. After dropwise adding, the mixture was stirred overnight with a natural warming. The next morning, 20 mL of perfluorohexane and 20 mL of 1N HCl were added to the reaction solution, and after stirring for 30 minutes, the aqueous phase was removed by separation. Subsequently, the perfluorohexane phase was washed with 10 mL of water, washed with 10 mL of methanol, washed twice with 10 mL of chloroform, and concentrated to dryness. The product obtained after the concentration was dissolved in 160 mL of a mixture of perfluorohexane:mXHF=10:1. The solution was filtered through a Kiriyama funnel packed with silica gel in 3 cm, and the filtrate was concentrated to dryness to obtain 0.997 g of alkynone represented by the following formula (yield: 43%).

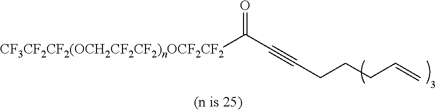

¹H NMR (mXHF, 400 MHz) δ: 2.40-2.50 (m, 6H), 2.67 (s, 2H), 5.40-5.47 (m, 6H), 6.07-6.20 (m, 3H);

¹⁹F NMR (mXHF, 400 MHz) δ: −83.98-−84.25, −85.40-−85.60, −86.58, −87.22, −123.66, −131.35-−131.66, −132.39

### (Synthesis Example 5-6) Synthesis of Oxime

After 0.5 g (0.125 mmol) of the alkynone obtained in Synthesis Example 5-5 was dissolved in 3 mL of AK 225 and 2 mL of DMSO, 0.087 g (1.25 mmol) of hydroxylamine hydrochloride and 0.103 g (1.25 mmol) of sodium acetate were added in this order, and the mixture was stirred overnight at a bath temperature of 43° C. The next morning, the mixture was washed twice with 10 mL of water, and then dried with 20 g of sodium sulfate. Subsequently, the solution was filtered through a Kiriyama funnel and concentrated to dryness to obtain 0.51 g of a crude oxime (Z form is a compound represented by the following formula) as a mixture of an E form and a Z form (yield: 100%).

The resulting crude oxime was used in the following reaction without purification.

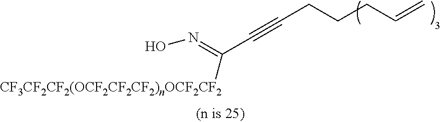

¹H NMR (mXHF, 400 MHz) δ: 2.40-2.50 (m, 6H), 2.65 (s, 2H), 5.40-5.50 (m, 6H), 6.10-6.25 (m, 3H), 7.00 (s, 1H).

### (Synthesis Example 5-7) Synthesis of Cyclized Product

After dissolving 0.68 g (0.17 mmol) of the crude oxime obtained in Synthesis Example 5-6 in 3 mL of simply dehydrated AK 225 and 0.5 mL of super-dehydrated chloroform, 0.0052 g (0.017 mmol) of AuCl₃ was added thereto, and the mixture was stirred at room temperature overnight. The next morning, the mixture was washed with 10 mL of water, and then dried with 20 g of sodium sulfate. Subsequently, the solution was dissolved in 5 mL of mXHF, filtered through a Kiriyama funnel packed with silica gel in 3 cm, extracted with 60 mL of mXHF, and the filtrate was concentrated to dryness to obtain 0.41 g of a cyclized product represented by the following formula (yield: 60%).

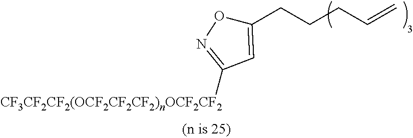

(n is 25)

¹H NMR (mXHF, 400 MHz) δ: 2.37-2.50 (m, 6H), 3.00 (s, 2H), 5.40-5.46 (m, 6H), 6.10-6.30 (m, 3H), 7.00 (s, 1H);

¹⁹F NMR (mXHF, 400 MHz) δ: −84.15-−84.17, −85.00-−86.00, −87.00, −88.55, −117.50-−117.70, −131.27-−131.98, −132.42.

### (Synthesis Example 5-8) Hydrosilylation of Cyclized Product

After 0.4 g (0.1 mmol) of the cyclized product obtained in Synthesis Example 5-7 was dissolved in 0.6 mL of simply dehydrated mXHF, 11 μl (0.5×10⁻³ mmol) of Karstedt catalyst and 3.6 μl (0.04 mmol) of aniline were added thereto in this order. After stirring at room temperature for 30 minutes, 0.102 mL (0.8 mmol) of trimethoxysilane was added and stirred at room temperature for 3 hours. After 3 hours, 0.6 mL of simply dehydrated HFE 7200 was added. To the reaction solution was added 0.076 g of activated carbon and stirred at room temperature for 30 minutes. After 30 minutes, the mixture was filtered through a filter and concentrated to dryness to obtain 0.38 g of hydrosilyl isoxazole represented by the following formula (yield: 95%).

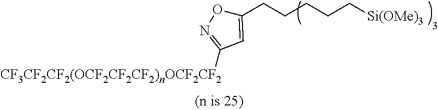

¹H NMR (mXHF, 400 MHz) δ: 0.98-1.08 (m, 6H), 1.60-1.77 (m, 6H), 1.91-1.95 (m, 6H), 2.96 (s, 2H), 3.90-4.10 (m, 27H), 7.21 (s, 1H);

¹⁹F NMR (mXHF, 400 MHz) δ: −84.00, −85.00-−86.00, −88.52, −117.36, −131.40-−131.69, −132.42.

As described above, the compound obtained in Example 1 can be used as a reaction raw material for various compounds as shown in Examples 3 and 5 and Synthetic Example 4. The compound obtained in Example 2 can also be used as a reaction raw materials for various compound as in Example 1.

### INDUSTRIAL APPLICABILITY

The fluoropolyether group-containing compound represented by formula (1a) or (1b) of the present disclosure is useful as an intermediate for various reactions.

What is claimed is:

1. A fluoropolyether group-containing compound of formula (1a) or formula (1b): 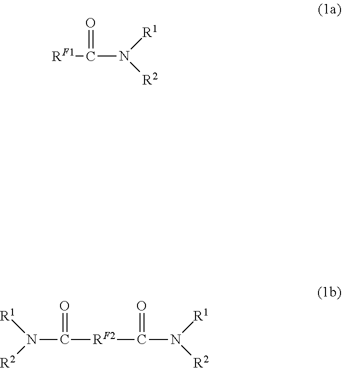
wherein
R^{F1} is each independently at each occurrence Rf¹—R^{F}—O_{q}—;
R^{F2} is —Rf²ₚ—R^{F}—O_{q}—;
Rf¹ is each independently at each occurrence a C₁₋₁₆ alkyl group optionally substituted with one or more fluorine atoms;
Rf² is a C₁₋₆ alkylene group optionally substituted with one or more fluorine atoms;
R^{F} is each independently at each occurrence a divalent fluoropolyether group;
p is 0 or 1;
q is each independently at each occurrence 0 or 1; and
one of R¹ and R² is an alkyl group having 1 to 10 carbon atoms or an alkoxy group having 1 to 10 carbon atoms, or R¹ and R² together form a group having a ring structure which is a 5 to 10-membered heterocyclic ring, or together form a group having a ring structure which is a condensed ring containing a 5 to 10-membered heterocyclic ring.

2. The fluoropolyether group-containing compound according to claim 1, wherein R^{F} is each independently at each occurrence a group represented by formula:
—(OC₆F₁₂)ₐ—(OC₅F₁₀)_{b}—(OC₄F₈)_{c}—(OC₃F₆)_{d}—(OC₂F₄)ₑ—(OCF₂)_{f}—
wherein
a, b, c, d, e and f are each independently an integer of 0 to 200, the sum of a, b, c, d, e and f is 1 or more, and the occurrence order of the respective repeating units enclosed in parentheses provided with a, b, c, d, e or f is not limited in the formula.

3. The fluoropolyether group-containing compound according to claim 1, wherein
one of R¹ and R² is a C₁₋₁₀ alkyl group and the other is a C₁₋₁₀ alkoxy group, or R¹ and R² together form a group having a ring structure, wherein the ring structure is a 5 to 10-membered heterocyclic ring, or together form a group having a condensed ring, wherein the condensed ring contains a 5 to 10-membered heterocyclic ring and a 3 to 10-membered ring other than the heterocyclic ring.

4. The fluoropolyether group-containing compound according to claim 1, wherein
one of R¹ and R² is a C₁₋₁₀ alkoxy group and the other is a C₁₋₁₀ alkyl group, or
R¹ and R², together with a nitrogen atom to which they are bonded, form a group of the following formula: 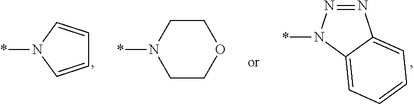
wherein * is a bond.

5. The fluoropolyether group-containing compound according to claim 1, wherein
one of R¹ and R² is a methyl group and the other is a methoxy group, or
R¹ and R², together with a nitrogen atom to which R¹ and R² are bonded, form a group of the following formula: 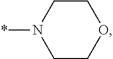 [SMILES: *N1CCOCC1]
wherein * is a bond.
